(19) United States
(12) Patent Application Publication
(10) Pub. No.: US 2007/0067199 A1
(43) Pub. Date: Mar. 22, 2007

(54) System and method for selecting a best-suited individual for performing a task from a plurality of individuals

(75) Inventors: David J. Shine, Hamden, CT (US); Satheesh B. Parachoor, South Windsor, CT (US)

Correspondence Address: MCCORMICK, PAULDING & HUBER LLP, CITY PLACE II, 185 ASYLUM STREET, HARTFORD, CT, 06103, US

(73) Assignee: Premise Development Corporation, Hartford, CT (US)

(21) Appl. No.: 11/230,195

(22) Filed: Sep. 19, 2005

(51) Int. Cl. G06F 15/02

(52) U.S. Cl. 705/9

(57) ABSTRACT

The present invention provides a computer implemented system and method for selecting a best-suited individual for performing a task from a plurality of individuals. The method including identifying a plurality of individuals for performing a task, receiving a task to be assigned to an individual, assessing the suitability of each of the plurality of available individuals for performing the task, and determining a best-suited individual for performing the task. The method includes evaluating for each individual the individual's current workload, the individual's proximity to a location of the current task and the individual's responsibility for performing the current task. In a preferred embodiment, the present invention is utilized to balance the workload of a hospital's housekeeping staff assigned to dean beds in a hospital thereby decreasing the bed turnover time and increasing the patient throughput of the hospital.

### FIELD OF THE INVENTION

The present invention generally relates to a staff assignment function for an organization and more particularly to a system and method for selecting a best-suited individual for performing a task from a plurality of individuals.

### BACKGROUND OF THE INVENTION

In managing a hospital or other health care facility, the bed turnover process is one of the most important components of patient throughput. In most hospitals, low occupancy rates are in part due to slow bed turnover processes. Beds which are dirty and left idle result in patient bottlenecks, inefficient use of the facility, and can cause frustration for both the patients and the hospital's staff. Additionally, empty beds can result in lost revenues, wasted meals and medication. Thus, slow bed turnover processes reduce the overall occupancy rate of the facility resulting in less revenue for the hospital and can increase other expenses of the facility.

Typically, slow bed turnover processes are due in part to delays in reporting of changes in the status of a bed throughout a bed turnover process. In most hospitals, a bed turnover process takes 4-8 hours. Currently, due to the high cost of medical services, the time a patient spends in a hospital for most procedures has reduced in recent years. Thus, a bed turnover process for each bed occurs more frequently, exasperating the problems of lost revenue and cost increases caused by slow bed turnover processes.

Often, slow bed turnover processes are partially the result of slow reporting of one or more of procedures involved in the bed turnover process thereby causing delays in subsequent procedures. These procedures can include, reporting of patient discharge orders; reporting of patient transport or departure; reporting of a dirty bed to housekeeping personnel; reporting of the completion of a bed cleaning assignment; reporting of a bed's availability. Also, delays can occur in the process of assigning a new patient to an available bed, and transporting of a new patient to an available bed.

In many cases, during much of a bed turnover process, the subject bed is dirty or idle. Thus, much of the delay is between the time a patient vacates a room and a housekeeping staff member reports the bed is dean and ready for a new patient. Delays in a bed cleaning process are often due to unbalanced workloads or cleaning assignments amongst a hospital's housekeeping staff. For example, if a number of beds in an area of a hospital assigned to a single housekeeper become vacant all at once or over a short period of time, the bed turnover process will be slow for the affected beds.

However, if the patient departures are reported to a central location and the bed cleaning assignments are distributed evenly throughout the housekeeping staff, the time for the bed turnover process can be drastically reduced. In one prior art system, the housekeeping staff for each shift is identified in an ordered list and each time a patient discharge occurs the next housekeeper on the list is notified and assigned the task of cleaning the associated bed. This system attempts to distribute the work more evenly however, can be the cause of wasted time, especially in large facilities.

Based on the foregoing, it is the general object of the present invention to provide a system and method for selecting a best-suited individual for a task from a plurality of individuals that improves upon, or overcomes the problems and drawbacks associated with prior art methods and systems.

### SUMMARY OF THE INVENTION

The present invention provides a computer implemented method for selecting a best-suited individual for performing a task from a plurality of individuals. The method includes, identifying a plurality of individuals for performing a task, receiving a task to be assigned to an individual, and assessing the suitability of each of the individuals for performing the task. Based on the suitability evaluations for each of the individuals, the best-suited individual for performing the task is identified. Thereafter, the task is assigned to the best-suited individual and the best-suited individual is notified of the assignment via a communication system when the assignment becomes a next assignment for the individual.

In a preferred embodiment, the system and method of the invention are directed to balancing bed and room cleaning tasks between the individual housekeepers of a housekeeping staff of a health care facility. The method first identifies a predetermined primary individual for the task and assesses the current workload for the primary individual. If the current workload for the primary individual is less than a predetermined maximum, the current task is assigned to the primary individual and depending on a priority level for the task, the current task is stored in a workload queue for the individual. In the case of an assignment having a stat priority level, the individual is immediately notified of the assignment and re-assigned to the stat assignment.

If the workload for the primary individual is equal to or above the maximum, the suitability of each of a plurality of individuals for performing the current task is evaluated. The evaluation includes assessing at least one of a workload of the individual, a proximity of the individual to a location of the task, and a level of responsibility of the individual with respect to the task.

The preferred embodiment includes evaluating the suitability of each individual for the task using the transform function:
Suitability, (S)=(Pgain*P)+(Lgain*L)+(Rgain*R)
where P represents the individual's proximity to the current task, L represents the individual's current workload and R represents the individual's responsibility for the current task. The factors, Pgain, Lgain, and Rgain are weighting terms, which can be used to bias the suitability algorithm in favor of each of the respective factors of Proximity, Workload and Responsibility.

Additionally, the present invention provides a computer system having a memory programmed with appropriate software applications for carrying out the above-identified method. Typically, in a hospital setting a server is coupled via a network to multiple workstations or PC's for use throughout the hospital by various personnel. Additionally, the system is coupled to and utilizes one or more communication systems such as an Interactive Voice Response System (IVR) or a wireless system, through which the housekeeping and other hospital personnel can be contacted or their locations monitored. Additionally, the system is configured to send telephone messages to mobile phones or pagers carried by the hospital staff.

Once a primary individual or a best-suited individual is identified for a current assignment, the system of the invention stores the current assignment in a workload queue for the individual. Upon completing each task, the individual reports the completed task and the system returns to the individual a notice of a next assignment in the individual's workload queue.

Additionally, each time a current task is assigned to an individual, the system automatically re-evaluates the suitability of each individual for each previously assigned and uncompleted task. Each task is then reassigned to the best-suited individual for the task. Thus, each time a new deaning task is requested, the suitability for each employee is re-evaluated for each task in each employee's workload queue.

Accordingly, the system and method of the present invention, provide for efficient balancing of housekeeping tasks between individual members of a housekeeping staff so that the overall bed turnover time for the facility is greatly reduced. In tests using the present invention system, an average bed turnover time was shown to be reduced from between 4-8 hours using prior art systems to an average time of about 96 minutes using the present invention system and method.

The foregoing and still other objects and advantages of the present invention will be more apparent from the description of the preferred embodiments of the invention in connection with the accompanying drawings wherein throughout the figures, like reference numerals describe like elements of the invention.

### BRIEF DESCRIPTION OF THE DRAWINGS

FIG. 1 is a diagram of a housekeeping process map showing an overview of the housekeeping process of a hospital including the system of the present invention as used for assigning tasks to the housekeeping staff.

FIG. 2 is a diagram showing an overview of a supervisory process of the housekeeping process of FIG. 1.

FIG. 3 is a flow chart summarizing the steps of the method of the present invention.

FIG. 4 is a flow chart showing a steady state process for the method of the present invention.

FIG. 5 is a copy of a BedXpress Dashboard™ web page including an icon indicating the state of enablement of the system of the present invention referred to as “Intelligent Workflow Engine” in a commercial embodiment thereof.

### DESCRIPTION OF PREFERRED EMBODIMENTS

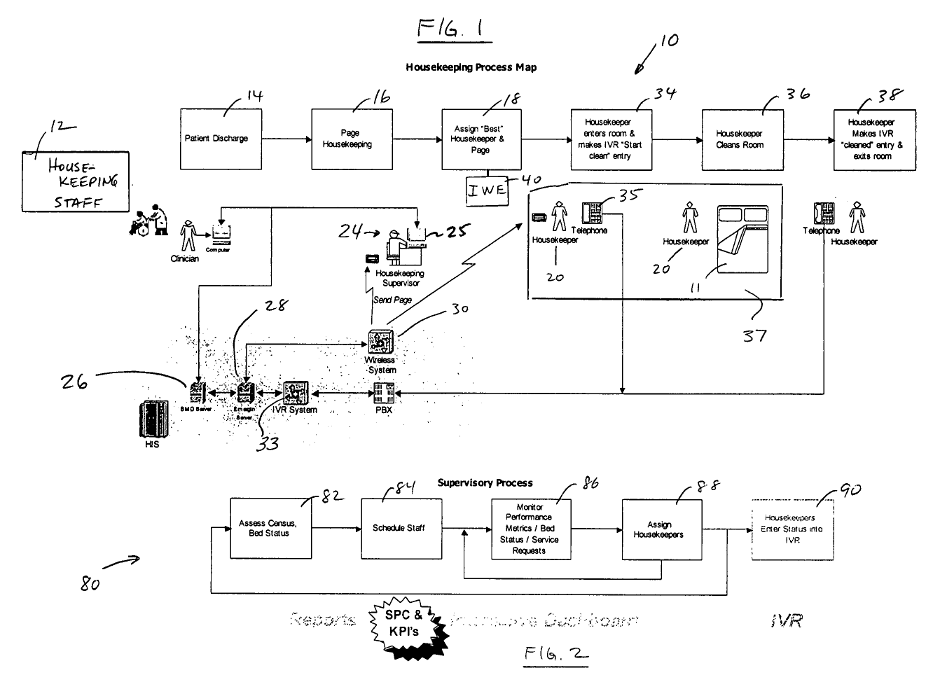

As shown in the Figures, an embodiment of the system and method of the present invention described herein is utilized in a hospital for determining the best-suited individual of a housekeeping staff of the hospital to be assigned the task of cleaning a hospital bed. Referring to FIG. 1, the system, generally referred to by the reference numeral 10, is utilized in a hospital for assigning the tasks of cleaning beds 11 to the best-suited individual of a housekeeping staff 12. Typically, following a patient discharge 14 the housekeeping staff is contacted (block 16) and a best-suited individual or team of the housekeeping staff 12 is identified for the task of cleaning the vacated bed and/or room at block 18. Additionally, at block 18, the individual 20 or housekeeper, identified as the best-suited to clean the bed 11 is assigned the task. As shown a housekeeping supervisor 24 is contacted and notified of the assignment via a pager. Alternatively, the supervisor 24 can be notified electronically via the computer 25 or workstation of the assignment.

In the preferred embodiment, the system 10 includes a server 26 coupled to a message server 28, which automatically forwards a page to the individual 20 via a wireless paging system 30 notifying the individual of the assignment. Once the individual 20 enters the room to perform the bed cleaning operation, the individual makes a “start clean” entry via an Interactive Voice Response System (IVR) 33 (Block 34). The IVR system 33 utilizes a room telephone 35 to transmit the start of the bed cleaning operation to the server 26. Additionally, the IVR system 33 can be utilized to assign tasks to the housekeeping staff 12. A housekeeping process, including cleaning the bed 11 and/or room 37 and preparing the bed and room for a next patient is performed by the best-suited individual 20 as shown at block 36.

Upon completion of the housekeeping process 36, the individual 20 utilizes the IVR system 33 to enter a notification that the housekeeping process at bed 11 and/or room 37 is complete and the bed is available. (Block 38). Upon entry of the completion notification for the bed 11 and/or room 37, the system 10 will return to the individual 20 a next assignment. Either the IVR system 33 or the paging system 30, or both, can be utilized for notifying the individual 20 of a next assignment. Typically, the IVR system 33 including the telephone 35 in the room 37 wherein the housekeeping task was just completed is utilized to communicate a next assignment to the individual 20 following entry of the completion notification by the individual.

The system 10 includes the server 26 having a processor programmed to perform the function of determining the best-suited individual 20 to perform a given task from a plurality of individuals referred to herein and in a commercial embodiment of the present invention as “Intelligent Workflow Engine” or “IWE”. The Intelligent Workflow Engine is shown in FIG. 1 at block 40 and includes a software application operable on the server 26 or an independent computer. In a basic embodiment of the present invention, the system 10 includes only a server 26 and the IWE 40 operable thereby.

In the preferred embodiment the IWE 40 determines whether a primary housekeeper pre-assigned to a housekeeping assignment is suitable for performing the assignment based on the workload of the primary housekeeper. In other embodiments the suitability of the primary housekeeper can be evaluated using factors such as workload (L), proximity to the assignment (P), or responsibility (R).

If the primary housekeeper is determined to be suitable for the assignment, based on configurable assignment rules, the system assigns the task to the primary housekeeper and enters the assignment in a work queue for the primary housekeeper. The selected housekeeper will be notified of the assignment when the assignment becomes the next assignment in their work queue. Preferably, the assignment notification is made to the housekeeper via both a pager and the IVR system and only a next assignment is given to the individual housekeeper. As set forth above, when using the IVR system 33, the next assignment is transmitted to the individual when a bed-clean or task completion entry is made to the system by the individual. In a preferred embodiment of the present invention, the assignment rules are configured such that the primary housekeeper will be assigned a current housekeeping assignment unless their work queue includes more than three assignments.

Typically, a hospital will define “groups” of housekeepers, with each group having a specific area of responsibility. Additionally, each member of the group is assigned a different “zone” for which they are considered the primary housekeeper. A zone will typically include multiple beds and/or rooms in a specific area of the hospital, which are assigned to a single primary housekeeper. A group of housekeepers could be, for example, all of the housekeepers assigned to various adjoining zones or all of the zones on the same floor or wing of a hospital. In other embodiments of the present invention, the responsibility of a housekeeper can also be based on the qualifications of the housekeeper with respect to a given task. For example, a novice housekeeper may not have the qualifications or experience necessary to clean or prepare certain equipment present in a room to be cleaned. Thus the novice housekeeper may have a lower level or zero level of responsibility for a room having certain equipment provided therein.

If the primary housekeeper is determined to be not suitable for performing a current assignment, and the IWE 40 is enabled, the IWE determines a next best-suited individual or housekeeper 20 for performing the current assignment as set forth in detail herein following.

If the IWE 40 is not enabled, the system 10 assigns the current task to the primary housekeeper regardless of the primary housekeeper's workload and notifies only the primary housekeeper of the task when the task is the next task for the primary housekeeper.

FIG. 5 shows a web page 42 from a BedXpress Dashboard™ including an icon 44 indicating the IWE 40 is enabled. The BedXpress Dashboard™ is a web-based application developed by Premise Development Corporation of Hartford, Conn. and used to monitor housekeeping activities of a hospital or group of hospitals or other health care facility.

The Bed Xpress Dashboard™ is typically utilized with a Bed Management Dashboard™ also provided by Premise Development Corporation, which includes a system for use in the management of housekeeping processes and other operations of a health care facility. Current versions of the Bed Management Dashboard™ include the Intelligent Workflow Engine 40 as a housekeeping assignment function and provide a toggle or other control switch for enabling/disabling the IWE 40. A description of the Bed Management Dashboard is provided in co-pending U.S. patent application Ser. No. 10/238,427 entitled “System and Method For Managing Patient Bed Assignments And Bed Occupancy In A Health Care Facility” filed Sep. 9, 2002, which is incorporated herein by reference in its entirety. Although the system and method of the present invention is shown and described herein as used in assigning tasks to a best-suited individual housekeeper amongst a housekeeping staff of a hospital, the present invention is not limited in this regard. In fact, in a hospital setting, the present invention can also be utilized effectively in assigning tasks to a patient transport team. Additionally, the present invention is applicable to numerous other applications wherein multiple individuals or teams thereof may be available to perform a current task efficiently.

To determine the best-suited individual for a current assignment, the IWE 40 evaluates the suitability (S) for each of the individuals of the hospital staff 12 or a subpart thereof, based on their respective workload (L), proximity to the current assignment (P) and individual's responsibility (R) for the current assignment. In a preferred embodiment the suitability (S) is determined using the following transform function:
S=(Pgain*P)+(Lgain*L)+(Rgain*R)

The proximity, (P) value is representative of the relationship of the zone of the housekeeper relative to a requested zone. In the illustrated embodiment, a Proximity Index (PIndex) for the relationship between each of the zones in a facility is determined once for the hospital as follows:
P=PIndex where IVR_Bed.Zone=RequestedZone, and IVR_Employee.zone=Present Zone

Thus, the system 10 utilizes identifies the IVR-Bed.Zone for the requested bed and utilizes the same as the Requested Zone. Whereas, the Present Zone of each employee is defaulted to the IVR_Employee.zone for each individual employee, or the assigned zone for the employee.

The following Zone Relationship Table is populated with the PIndex determined for the relationship between the various zones in a facility and stored for use thereafter for the suitability evaluations. Thus, the Zone Relationship Table is a one-time entry for a facility.

Zone Relationship Table

| | | |
|---|---|---|
| Pindex | PresentZone | RequestedZone |

If the hospital is provided with an indoor positioning system capable of providing an actual location within the facility for each of the housekeepers, the system of the present invention can be configured to utilize data representative of the actual location of each housekeeper to determine the proximity of each housekeeper relative to the requested zone.

The Workload or (L) value is determined for each housekeeper in accordance with the following:
L=LIndex depending on the number of pending work units for the housekeeper.

Usually, the LIndex is fixed for the hospital and stored in a table such as the following table:

Load Balance Table

| | |
|---|---|
| Lindex | No. of Pending |
| | WorkUnits |

In the preferred embodiment, a regular cleaning is considered a single work unit whereas a double cleaning is considered as 2 work units. Following is a WorkLoad Table created for a typical hospital and utilized in a preferred embodiment of the present invention. The WorkLoad table is a one-time entry to the system for the entire hospital. A regular cleaning is considered as a baseline to calculate the workunits for the other cleaning types.

IWE_WorkLoad Table

| | | | IVRStatusID |
|---|---|---|---|
| | | Time for | (FK to |
| Cleaning Type | Work Unit | cleaning | IVRStatus.IVRStatusID) |
| Regular | 1 | 30 | 10 |
| Contact Isolation | 1.25 | 37 | 11 |
| Airborn | 1.25 | 37 | 12 |
| Droplet | 1.5 | 45 | 13 |
| Combo | 1.5 | 45 | 14 |
| Doubleclean | 2 | 60 | 15 |

In the illustrated embodiment, the Responsibility or (R) value for each housekeeper is representative of a group number for the group the housekeeper is assigned to. Alternatively, as set forth above, the Responsibility value that each housekeeper has with respect to a task can be determined based on other factors including qualifications of the individual housekeeper with respect to a task.

The gain factors, Pgain=Proximity Gain; Lgain=Load Gain; Rgain=Responsibility Gain; represent optional weighting terms which can be used to bias the suitability transform algorithm in favor of each of these attributes. For example, the proximity gain can be increased if the hospital is a large facility wherein the various zones are spread over a considerable distance.

A suitability table is used to store these predetermined parameters as follows. Typically, the parameters in the suitability table should be considered dynamic as they are likely to change for different shifts.

IWE_Suitability table

| | | | | | | |
|---|---|---|---|---|---|---|
| BedZoneID | EmployeeZoneID | ShiftID | Pgain | Lgain | R | Rgain |

Each time a housekeeping request is received, (i.e., a bed cleaning request) the IWE 40 performs a suitability evaluation using the suitability shift. The following Suitability Matrix is used to store data and the results of the suitability evaluations for each housekeeper:

Suitability Matrix

| | | | | | | | | | | |
|---|---|---|---|---|---|---|---|---|---|---|
| Housekeeper | BedZone | EmpZone | Shift | Proximity (P) | Pgain | Work | Lgain | (R)Group | Rgain | Suitability |
| | | | | | | Load | | | | |
| | | | | | | (L) | | | | |

In the Suitability determination, each term that is not a gain value, is represented as an index value between 1 and 10. The lower the index value, the less suitable the attribute. Thus, the housekeeper having the highest resulting Suitability (S) should be the housekeeper that is selected for a current assignment. Therefore, each housekeeper will be assessed using the transform function, then the one with the highest suitability ranking will be identified as best-suited to perform the current assignment. In the event of a tie, the IWE 40 selects the individual having a zone ID equal to or the closest to the zone of the requested bed. Following the suitability evaluation the task is assigned to the best-suited housekeeper and added to that employee's work queue.

Each time a cleaning request is received, the IWE 40 re-evaluates all pending housekeeping assignments for the purpose of load balancing. Thus, each of the assigned tasks in a housekeeper's work queue are reevaluated and may be re-assigned each time a new cleaning request is received.

A priority system is also provided so that a cleaning request can be assigned one of various levels of priority, which are considered prior to assignment of a current assignment. Preferably, one of the following cleaning priorities are assigned to each cleaning request to be processed by the system 10 prior to assigning the task to a housekeeper:

Normal: determine most suitable housekeeper and add the task at the end of the current work queue for the housekeeper.

Dirty-Next: determine the most suitable housekeeper and add the task as the next task in the current work queue for the housekeeper.

Stat: identify the primary housekeeper for the task and reassign the primary housekeeper from their current assignment to the present request.

In this case, the system 10 will page the primary housekeeper.

At the start of a shift, the system 10 will populate a Work Allocation Queue as well as the work queues for each employee housekeeper to a predetermined allowed number of work units without utilizing the suitability function or suitability matrix. Any unassigned work units, which are above the allowed number as well as any subsequent housekeeping request will be processed using the suitability function as set forth above. The system 10 is configurable to reallocate all pending tasks at a predetermined time prior to the actual shift change time so that the work queues are current and populated at the start of the shift. During the re-allocation, the Work Allocation Table is also updated in accordance with the shift change.

Referring to FIG. 3, the method of the present invention includes a process generally designated by the reference numeral 50 showing the process steps performed by the Intelligent Workflow Engine 40.

The process starts at block 52 wherein upon arrival of an individual to his/her workplace, the system 10 is initialized with information corresponding to the arriving individual or employee. Also, prior to a shift change, the system 10 is initialized with information corresponding to a plurality of shift employees as set forth above. (Block 52).

At block 54, the process loops until a job request is received. The job request may be initiated through an admissions department or system, an IVR request, or from various other requesters. Typically, a job request includes information including the type, location, and priority of the request, as well as the date and time the request was issued.

At block 56, the primary housekeeper for the requested job is identified, and selected as the default housekeeper if the work queue for the selected housekeeper contains less than the allowed number of work units.

Depending on the priority level of the requested job, the IWE 40 processes the task as follows:

If the task is designated, “Next” priority, (Dirty-Next) (Block 58), the system 10 will determine the most suitable housekeeper using the transform function and add the task as the next task in the current work queue for that housekeeper. (Block 60).

If the task is designated, “Stat” priority, (Block 62), the system 10 will identify the primary housekeeper assigned to the task and reassign the primary housekeeper from their current assignment to the requested task. The system 10 will notify the housekeeper of the reassignment via a page. (Block 64). A new job request will be generated for the uncompleted task and it will be reassigned in accordance with its designated priority level.

If the task is designated, “Normal” priority, the system defaults to block 66 wherein the work queue for the primary housekeeper assigned to the task is queried to determine the primary housekeepers current workload. If the primary housekeeper's workload is below a predetermined maximum workload, the system 10 evaluates the transform function for each of (n) employees, populates a suitability matrix according to the transform evaluations, selects the employee with the highest suitability index, S(n), and assigns the task to the selected employee. (Block 68). The process ends at block 70 once the requested (current) task is assigned to an employee.

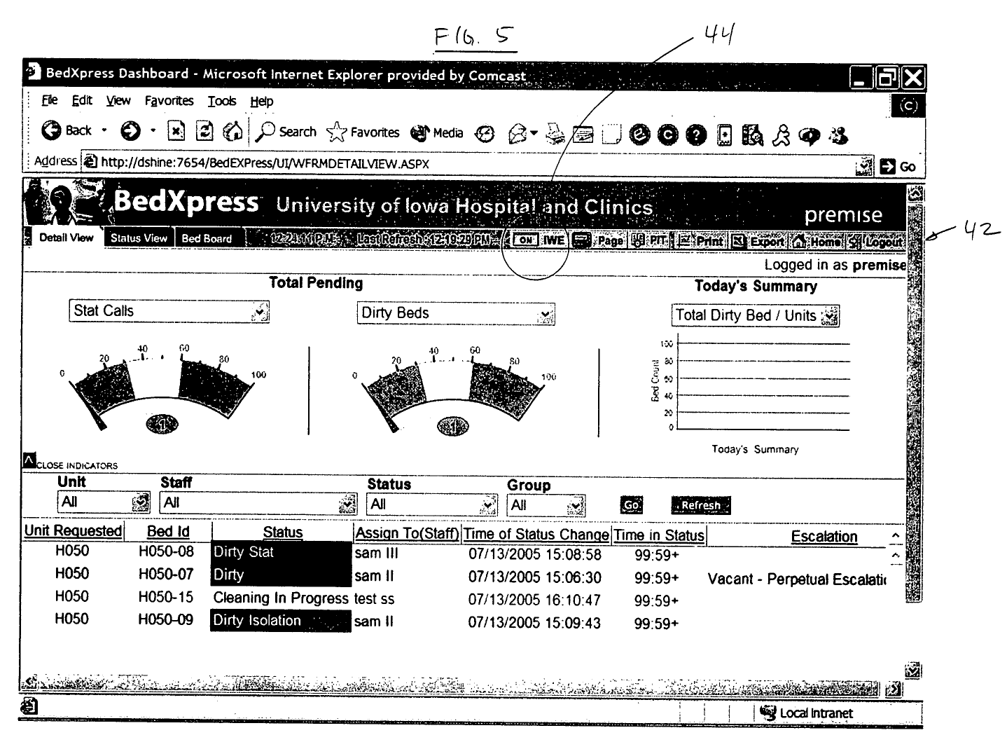

FIG. 4 illustrates a steady state process for the Intelligent Workflow Engine 40 wherein the IWE 40 periodically rebalances the workload for each employee by recalculating the suitability of each employee for each task currently in the Work Allocation Queue having a normal priority designation. Each task is re-assigned as necessary in accordance with the results of the suitability evaluations. (Blocks 72, 74). This reallocation can be configured to occur at one or more predetermined times throughout a shift as well as following each task assignment.

Each time a housekeeper or employee completes an assignment and transmits a job completion entry via the IVR system, the system 10 returns a next job assignment via the IVR at the location of the completed job, a pager, or via other communication means. (Block 76).

An escalation process provides automatic notification to a housekeeping supervisor 24 if a current job is not completed within a predetermined maximum time limit or if a next job is not started within a predetermined period of time relative to the start time of the previous job or the number of work units of the prior job. Other criteria can also be utilized to determine whether a notification as to the status of current or pending jobs is transmitted to a supervisor. The system 10 is configurable with respect to pre-conditions related to supervisor notifications.

The system 10 provides for notifications to employees and supervisors via electronic messages, pages, IVR transmissions, telephone messages and is configurable to utilize alternate means for notification purposes.

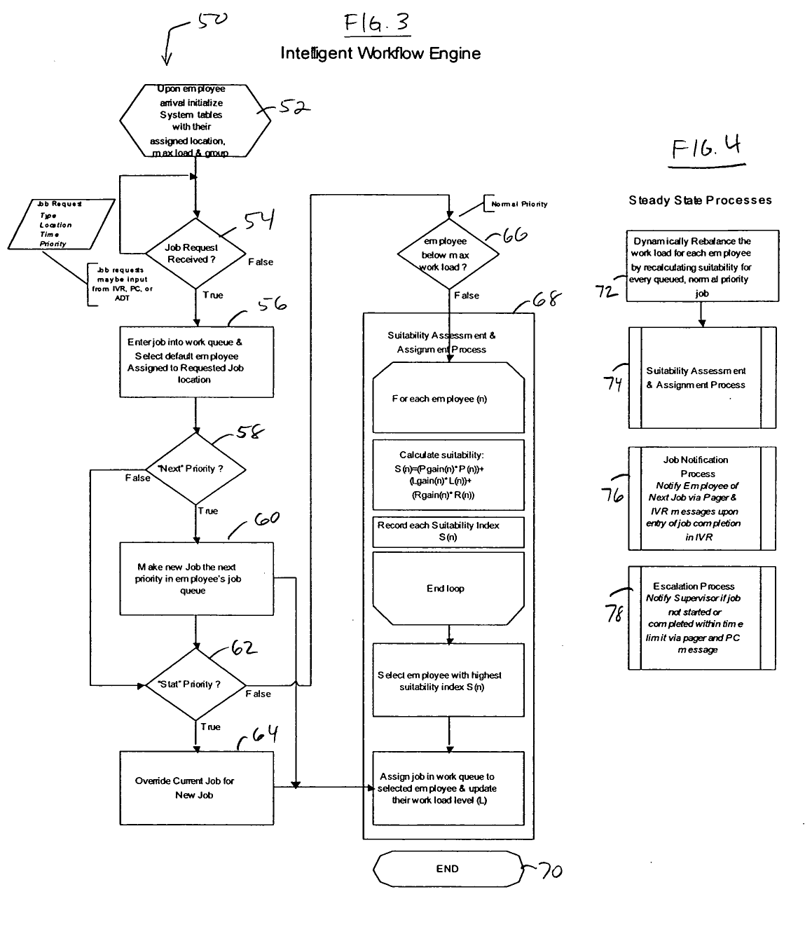

Referring to FIG. 2, a supervisory process 80 is illustrated wherein hospital administrator or other supervisor is provided access to the census of the hospital and the status of the beds therein. (Block 82). Additionally, the system provides means for a supervisor to schedule an appropriate staff (Block 84), monitor performance, analyze the status of the beds in the hospital or hospital network as to turn-around time, available time, dirty time; performance of housekeeping staff by group, zone, and individual housekeepers. (Block 86). At block 88, the system 10 allows the supervisor to assign housekeepers to current or pending housekeeping assignments outside of the IWE system 40. Thus, whether or not the IWE is enabled, a housekeeping supervisor can assign current or pending housekeeping assignments to an individual housekeeper. Further, the system enables the housekeeping supervisors and/or staff to enter a status of a current or pending assignment to the system via the IVR system. (Block 90).

The foregoing description of embodiments of the present invention system and method for determining a best-suited individual for performing a task from a plurality of individuals have been presented for the purpose of illustration and description and are not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A computer implemented method for selecting a best-suited individual for performing a task from a plurality of individuals, the method comprising:
identifying a plurality of individuals for performing a task,
receiving a task to be assigned to an individual,
assessing the suitability of each of the plurality of available individuals, and
determining a best-suited individual for performing the task.

2. The method of claim 1 including assigning the task to the best-suited individual.

3. The method of claim 1 wherein assessing the suitability of each of a plurality of available individuals further includes identifying a primary individual for the task, and determining a workload for the primary individual.

4. The method of claim 3 wherein determining a best-suited individual for performing the task further includes identifying the primary individual if the workload for the primary individual is less than a predetermined threshold.

5. The method of claim 1 wherein assessing the suitability of each of a plurality of available individuals includes assessing at least one of a workload of the individual, a proximity of the individual to a location of the task, and a level of responsibility of the individual with respect to the task.

6. The method of claim 2 wherein the step of assigning further includes notifying the best-suited individual of the task.

7. The method of claim 2 further comprising assigning a priority level to the task wherein the step of assigning includes considering the priority level of the task.

8. The method of claim 5 wherein assessing the level of responsibility of the individual with respect to the task further comprises comparing at least one qualification of the individual to a requirement of the task.

9. The method of claim 5 wherein assessing the suitability of each of a plurality of individuals includes determining a suitability value for each individual including summing a weighted value for each of the individual's proximity to the location of the task a current work load of the individual, and the individual's responsibility for the current task.

10. The method of claim 9 wherein the step of determining a suitability value for each of n individuals includes for each individual evaluating the function:
S(n)=(Pgain(n)(P(n))*P(n))+Lgain(n)*L(n)+Rgain(n)*R(n)),
where S(n) is the suitability of the n^{th} individual for performing the current task.

11. A computer implemented system for selecting a best-suited individual for performing a task from a plurality of individuals comprising:
a server computer coupled to a memory and a display;
said server computer programmed for receiving information pertaining to a current task, retrieving and evaluating stored data for each of a plurality of individuals for determining a suitability value for each said individual with respect said current task, and identifying a best suited individual for performing said current task from said plurality of individuals.

12. The system according to claim 11 wherein the server computer is further programmed to assign the current task to the best-suited individual.

13. The system according to claim 11 wherein the server computer is coupled to a communications system and further programmed to notify the best-suited individual of the assignment of the current task via the communications system.

14. The system according to claim 11 wherein the server computer utilizes an algorithm for determining the suitability value for each individual, the algorithm utilizing a factor representing at least one of the individuals current workload, the individuals proximity to a location of the current task, and the individuals responsibility for the current task.

15. The system according to claim 14 wherein the algorithm includes a weighting factor for biasing the result of the algorithm in favor of at least one of the individuals current workload, proximity to the current task, and responsibility for the current task.

16. The system according to claim 11 further comprising means for storing a workload queue for each individual's assigned tasks, wherein following the assignment of the current task, the suitability of each individual for each assigned task is reassessed and reassigned to the best-suited individual.

17. The system according to claim 12 further comprising means for receiving notifications via the communications system from an individual upon the completion of a task thereby initiating a transmission of a next assignment notification to the individual.

18. The system according to claim 11 further comprising means for populating a workload queue for a plurality of individuals with pending assignments prior to the start of a work shift.
